(19) United States
(12) Patent Application Publication
(10) Pub. No.: US 2006/0261606 A1
(43) Pub. Date: Nov. 23, 2006

(54) Sliding latch with rotational member

(76) Inventor: Joseph J. Bella, Plainfield, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/133,907

(22) Filed: May 20, 2005

(51) Int. Cl. E05C 19/00

(52) U.S. Cl. 292/304

(57) ABSTRACT

A slidable latch mechanism is provided that may be used to latch and unlatch rotatable structures, such as doors or compartments in automobiles that rotate or pivot when they open or close. The slidable latch mechanism includes structure that permits the latch mechanism to remain stationary when mounted to an inclined slot and when subject to the forces of gravity. This structure will hold the latch mechanism in position when not engaged by a pin of the rotatable structure and, when engaged by the pin of the rotatable structure, the structure that holds the latch mechanism in position will permit the latch mechanism to slide or move along the slot and thus allow the latching or unlatching of the rotatable structure.

### FIELD OF THE INVENTION

The present invention relates generally to sliding latches that incorporate a push-push configuration: and more specifically to sliding latches that may be used with rotational members.

### BACKGROUND OF THE INVENTION

It is known that latch mechanisms are used to latch one slidable structure to another stationary structure. Many of these know latch mechanisms use a “push-push” configuration. With this configuration, the mechanism becomes latched by a pushing action from the user, and becomes unlatched by a similar or identical pushing motion. Typically, the known latching mechanisms are used in automobiles for the latching and unlatching of slidable cup holders, or similar slidable compartments. For some time, the known latch mechanisms included a relatively large number of pieces and were complicated to manufacture, assemble and install. This added complexity resulted in a higher cost assembly. To overcome these problems, the latch mechanism described in U.S. Pat. No. 6,056,333 to Wach, and assigned to Illinois Tool Works, Inc., was developed which reduced the number of parts, reduced the cost to manufacture, and provided a solid, robust feel to the user.

The present invention is directed at improving upon the known latch mechanisms and in particular the mechanism described: in U.S. Pat. No. 6,056,333 by providing a latch mechanism that may be used with storage compartments that rotate or pivot, as well as compartments that slide.

### SUMMARY OF THE INVENTION

The present invention is directed to a slidable latch mechanism that may be used to latch and unlatch rotatable or pivotable structures, such as doors or compartments that rotate or pivot when they open or close. The slidable latch mechanism also includes structure that permits the latch mechanism to remain stationary when mounted in an inclined position and subject to the forces of gravity. More specifically, the latch mechanism includes structure that will hold the latch mechanism in position when the mechanism is mounted in an inclined slot and not engaged by a pin of the rotatable compartment. When engaged by the pin of the rotatable compartment, the structure that holds the latch mechanism in position will still permit the latch mechanism to slide or move to thereby facilitate the latching or unlatching of the rotatable compartment. Moreover, the invention uses a minimal number of components, resulting in reduced costs and improved assembly operations.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a plan view of an exemplary embodiment of a latch mechanism of the present invention.

FIG. 2 is a side view of the latch mechanism of FIG. 1.

FIG. 3 is another plan view of the latch mechanism of FIG. 1.

FIGS. 4A-4D are plan views of various positions of a rotatable member engaging the latch mechanism of FIG. 1

FIG. 5 is an isometric view of an exemplary rotatable structure.

FIG. 6 is a partial view of an exemplary rotatable structure mounted to a body and illustrating a mounted latch mechanism of the invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE EMBODIMENTS

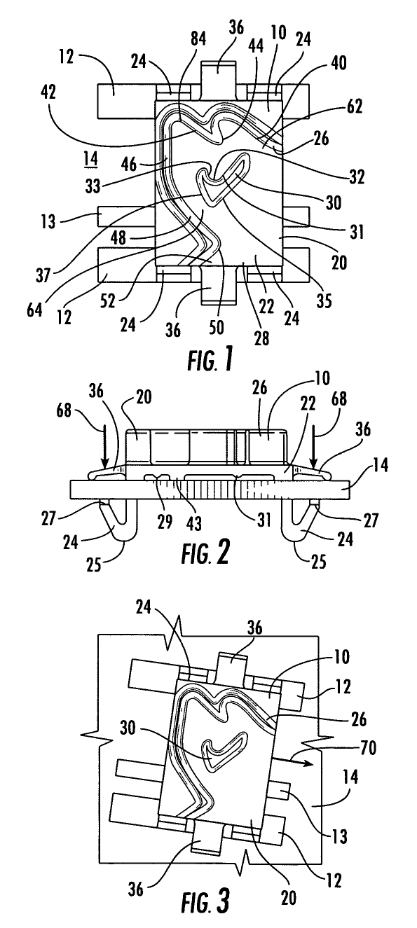

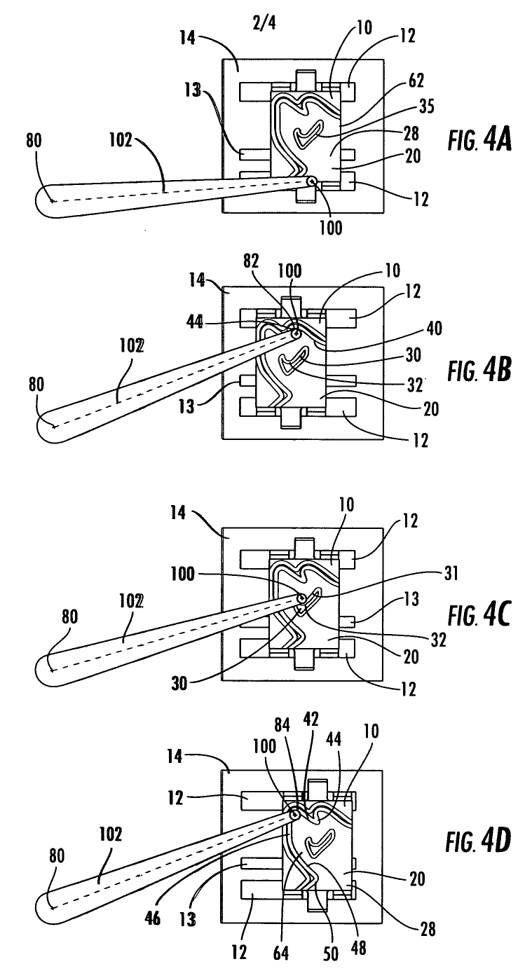

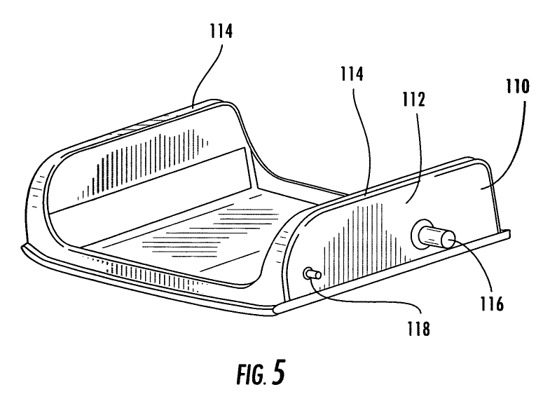

Referring to FIGS. 1 and 2, an exemplary embodiment of a sliding latch mechanism 10 is depicted. As shown in FIG. 1, the latch mechanism 10 may be mounted to a pair of slots 12 that are formed in a body 14, such as an interior wall of an automobile, and may move along the slots 12. The latch mechanism 10 includes a latching body 20 that is designed to latch a pin or protrusion, such as pin 100 depicted in FIG. 4, to the latch mechanism at various positions on the latch mechanism, as discussed below. With the invention, the pin or protrusion 100 may be mounted to a rotational member 102 such as a rotating door or compartment. To operate the latch mechanism 10, the user merely pushes the rotatable door or compartment to latch the door or compartment and pushes it again to unlatch the door or compartment as described below. The latch mechanism 10 thus provides a “push-push” operation to latch or unlatch the rotatable door or compartment.

The latching body 20 defines a planar base 22 and a plurality of mounting legs 24 extending outwardly from the base 22. The legs 24 are sized and shaped to snap fit within the slots 12 formed in the body 14. As shown in FIG. 2, the legs 24 define pointed ends 25 that permit the latching body 20 to be snap fit into the slots 12. The legs 24 further define ledges 27 that permit the latching body 20 to be held within the slots 12, and permit the latching body 20 to slide along the slots 12.

As can be seen in FIG. 2, ridges 29 and 31 may be formed on the underside of planar base 22 in the direction of travel of the latching body 20 in order to lift the planar base 22 from the body 14 and reduce the friction between the base 22 and the body 14. In addition, a guide rail 43 may extend outwardly from the underside of the planar base 22 to engage a slot 13 formed in the body 14. As depicted in FIG. 1, the slot 13 will extend in a substantially parallel manner with the slots 12. The rail 43 will serve to guide and align the latching body 20 along the slot 13 as well as to guide the legs 24 along the slots 12. The rail 43 and slot 13 configuration will also create a more robust mounting of the latching body 20 to the body 14.

Referring to FIGS. 1-3, the latching body 20 defines laterally extending flexible arms 36 on opposing sides of the base 22. The flexible arms 36 provide biasing forces that further provide points of pressure contact between the latch mechanism 10 and the body 14. The flexible arms 36 permit the latch mechanism to slide along the slots 12 and yet prevent the latch mechanism 10 to slide on its own due to an incline or gravity. The flexible arms 36, which may also be referred to as pressure arms, are slightly deflected when the latch mechanism 10 is mounted to the slots 12. This configuration results in the flexible arms 36 exerting a small force on the body 14 as depicted by force arrows 68 (FIG. 2). The force is small enough to allow the latch mechanism 10 to slide along the slots 12 when the mechanism is engaged by the pin 100 but large enough to prevent to the latch mechanism to slide on its own due to gravity. As exemplified by FIG. 3, the latch mechanism 10 may be mounted in an inclined manner. Without the use of the flexible arms 36, the latch mechanism 10 will tend to slide in the direction depicted by direction arrow 70 due to the forces of gravity.

Referring to FIG. 2, extending outwardly from the base 22, opposite the direction of the legs 24, is a cam path or guide path wall 26. As shown in FIG. 1, the cam path wall 26 forms a cam path mouth 28. Also extending outwardly from the base 22 is an island wall 30 that defines a curved notch 32. As described below, during the opening and closing operation of a rotatable door or compartment, the pin or protrusion 100 will enter the cam path mouth 28, travel along the cam path wall 26 and island wall 30, and will seat in the notch 32.

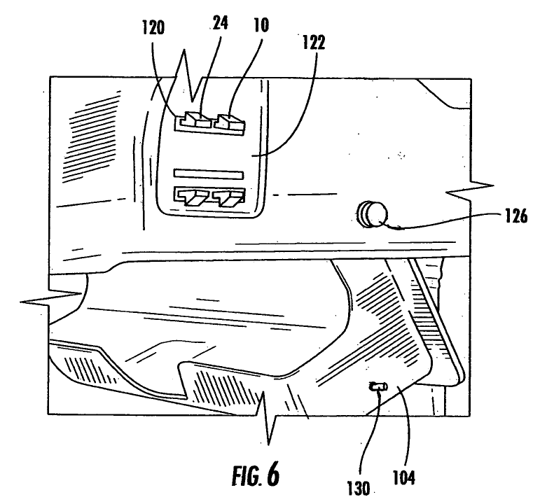

As illustrated by FIG. 1, the cam path wall 26 defines generally a curvilinear shape that permits the latch mechanism 10 to operate with a rotational member such as the rotational member 102 generally depicted in FIG. 4, the rotational member 104 depicted in FIG. 6, the rotational member 110 depicted in FIG. 5, or other similar rotational members or compartments. The cam path wall 26 defines multiple wall portions including curvilinear wall portions 40 and 42. The wall portions 40 and 42 are joined together at a rounded apex wall portion 44. The wall portion 42 extends to a generally straight wall portion 46 which joins to a curvilinear wall portion 48. The wall portion 48 extends to a rounded apex wall portion 50 which joins the wall portion 48 to a wall portion 52. The wall portion 52 extends at substantially a right angle with the wall portion 48. However, other angles are possible.

The island wall 30 is formed near the center of the base 22 and is substantially surrounded by the cam path wall 26. The island wall 30 defines the curved shape notch 32 that is formed by curvilinear wall portions 31 and 33. The island wall 30 further defines lower curvilinear wall portions 35 and 37, which in use, direct the pin 100 around the island wall 30. As described below, the pin 100 will sit on the curved shape seat 32 when the rotational member 102, for example, is in the closed or retracted position. The island wall 30 divides the interior area formed by the wall 26 into an inlet channel 62 and an outlet channel 64.

As illustrated by FIG. 4A, the pin 100 is typically round-shaped (though other shapes are possible) and travels along a generally arcuate path when the rotational member 102 is rotated about an axis of rotation 80. As the pin 100 enters the latching body 20 and engages the cam path wall 26, the relative arcuate direction of pin travel combined with the curvilinear shape of the cam path wall 26 will cause movement of latching body 20 within the slots 12 and effect the latching and unlatching of the rotational member 102 to the latching body 20. This movement is exemplified by FIGS. 4A-4D.

Referring to FIGS. 4A-4D, the operation of the latch mechanism 10 and the engagement of the pin 100 of the rotational member 102 is illustrated. As depicted, the pin 100 will rotate about the axis of rotation 80. As shown in FIG. 4A, the pin 100 will enter the mouth 28 and rotatably travel along the inlet channel 62 until the pin 100 contacts the wall portion 35 of the island wall 30. As the pin continues to rotate about the axis of rotation 80, the pin 100 will travel along the wall portion 35 and urge the latching body 20 in a leftward direction, as illustrated by FIG. 4B.

Referring to FIG. 4B, the pin 100 will pass the island wall 30 and continue to the wall portion 40 where it will travel along the wall portion 40 until the pin 100 reaches a junction 82 between the wall portion 40 and the apex 44. Once the pin 100 reaches this position, the user will sense that the rotational member 102, such as a door, is closed and will release the rotational member 102. The pin 100 will then travel from the junction 82 toward the notch 32 of the island wall 30.

As shown in FIG. 4C, the pin 100 will contact the wall portion 31 and urge the latching body 20 in the rightward direction until the pin 100 seats within the notch 32. Once in the notch 32, the rotational member 102 is latched to the latching body 20 until the user pushes again on the rotational member 102 to unlatch the rotational member. Once this occurs, referring to FIG. 4D, the pin 100 will rotatably travel along the apex 44 and the wall portion 42 until the pin 100 reaches a junction 84 between the wall portion 42 and the wall portion 46. As depicted in FIG. 4D, this pin 100 movement urges the latching body 20 along the slots 12 to the rightward direction. Once the pin 100 reaches the junction 84, the user will sense or detect that the rotational member 102 cannot rotatably travel any farther and will release the rotational member 102 causing the rotational member 102 to move to the open or unlatched position. As the pin 100 moves to the open or unlatched position, the pin 100 will rotatably travel across the outlet channel 64 along the wall portions 46 and 48 and the apex portion 50 until the pin 100 exits out the mouth 28. To close or latch the rotational member 102 to the latch mechanism 10, the action described above is repeated.

Referring to FIG. 5, another exemplary rotational member 110 is depicted and includes a rotational body 112 that defines opposing side walls 114 and pivot pins 116 that extend outwardly from the side walls 114 and serve to mount the rotational body 112 to other structures. The pivot pins 116 provide an axis of rotation for the rotational member 110. Also extending outwardly from the side walls 114 are protrusions or pins 118 that engage the latch mechanism 10, as described above. The latch mechanism 10 of the invention permits the latching and unlatching of the exemplary rotational member 110.

Referring to FIG. 6, the latch mechanism 10 is shown mounted through slots 120 formed in a wall 122 of a structure, such as an interior wall of an automobile or the like. A rotational member 104, such as a storage compartment typically found in an automobile, is pivotably mounted to the wall 122 through the use of opposing pivot pins 126. The pivot pins 126 provide the axis of rotation for the rotational member 104. The rotational member 104 also includes a latching body engagement member 130 such as a protrusion or pin extending outwardly from the rotational member 104. The latching body engagement member 130 will engage the latch mechanism 10 in the manner described above to facilitate the closing and opening of the rotational member 104.

Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A latch mechanism for latching a rotational member comprising:
a latching body mountable to a wall, the latching body defining a cam path wall and an island wall, the latching body further defining outwardly extending legs and at least one outwardly extending pressure arm that contacts the wall to hold the latching body in position, and
a pin mounted to the rotational member, the pin engaging the cam path wall and island wall as the rotational member rotates between an unlatched position and a latched position.

2. The latch mechanism of claim 1 wherein the wall defines at least one slot for receiving the outwardly extending legs.

3. The latch mechanism of claim 1 wherein the cam path wall defines curvilinear wall portions.

4. The latch mechanism of claim 3 wherein two curvilinear wall portions are joined together by an apex wall portion.

5. The latch mechanism of claim 1 wherein the latching body defines a rail extending outwardly from the latching body.

6. The latch mechanism of claim 1 wherein the latching body defines at least one ridge extending outwardly from the latching body.

7. The latch mechanism of claim 1 wherein the island wall and cam path wall form an inlet channel and an outlet channel.

8. The latch mechanism of claim 1 wherein the rotational member is a storage compartment.

9. The latch mechanism of claim 1 wherein the at least one outwardly extending pressure arm is two opposing pressure arms.

10. A latch mechanism for latching a rotational member comprising:
a latching body mountable to a wall, the latching body defining a cam path wall further defining at least one curvilinear wall portion, and an island wall, the latching body further defining outwardly extending legs and opposing pressure arms that contact the wall to hold the latching body in position, and
a protrusion mounted to the rotational member, the protrusion contacting the at least one curvilinear wall portion and island wall as the rotational member rotates between an unlatched position and a latched position.

11. The latch mechanism of claim 10 wherein the wall defines a first slot for receiving the outwardly extending legs.

12. The latch mechanism of claim 10 wherein the at least one curvilinear wall portion are multiple curvilinear wall portions.

13. The latch mechanism of claim 10 wherein the latching body defines a rail extending outwardly from the latching body, the rail engaging a second slot formed in the wall.

14. The latch mechanism of claim 10 wherein the latching body defines at least one ridge extending outwardly from the latching body.

15. The latch mechanism of claim 10 wherein the island wall and cam path wall form an inlet channel and an outlet channel.

16. A latch mechanism for latching a rotational member of an automobile comprising:
a latching body mountable to an interior wall of the automobile, the latching body defining at least one curvilinear wall portion and at least one pressure arm that contacts the wall to hold the latching body in position, and
a latching body engagement member mounted to the rotational member, the latching body engagement member contacting the at least one curvilinear wall portion as the rotational member rotates between an unlatched position and a latched position.

17. The latch mechanism of claim 16 wherein the latching body defines mounting legs for mounting of the latching body to the interior wall.

18. The latch mechanism of claim 17 wherein the at least one curvilinear wall portion are multiple curvilinear wall portions, and wherein the latching body defines a rail extending outwardly from the latching body, the rail engaging a slot formed in the interior wall.

19. The latch mechanism of claim 18 wherein the latching body further defines an island wall, and wherein the island wall and multiple curvilinear wall portions form an inlet channel and an outlet channel.

20. The latch mechanism of claim 19 wherein the latching body engagement member is a pin, and wherein the at least one pressure arm is two opposing pressure arms that bias towards the interior wall.
